(19) United States
(12) Patent Application Publication
(10) Pub. No.: US 2013/0182539 A1
(43) Pub. Date: Jul. 18, 2013

(54) MULTIPATH REFLECTION PROCESSING IN ULTRASONIC GESTURE RECOGNITION SYSTEMS

(71) Applicants: David B. Barkin, San Francisco, CA (US); Joshua Posamentier, Oakland, CA (US)

(72) Inventors: David B. Barkin, San Francisco, CA (US); Joshua Posamentier, Oakland, CA (US)

(73) Assignee: TEXAS INSTRUMENTS INCORPORATED, Dallas, TX (US)

(21) Appl. No.: 13/349,875

(22) Filed: Jan. 13, 2012

(51) Int. Cl. G01S 15/06

(52) U.S. Cl. 367/99

(57) ABSTRACT

A method includes identifying a position of a static reflector near an ultrasonic transmitter. The method also includes transmitting ultrasonic signals from the ultrasonic transmitter. The method further includes receiving reflected ultrasonic signals at an ultrasonic receiver, where the received ultrasonic signals include a direct reflection directly from a target and a multipath reflection indirectly from the target via the reflector. In addition, the method includes identifying a location of the target using the reflections and the identified position of the reflector. The identified position of the reflector can be used to determine which pulses in the received ultrasonic signals are from the direct reflection and which pulses in the received ultrasonic signals are from the multipath reflection. The pulses in the received ultrasonic signals from the multipath reflection could be discarded or combined with the pulses in the received ultrasonic signals from the direct reflection.

### TECHNICAL FIELD

This disclosure is generally directed to user interfaces. More specifically, this disclosure is directed to multipath reflection processing in ultrasonic gesture recognition systems.

### BACKGROUND

Many electronic devices support the use of gesture recognition. For example, some electronic devices use pulse-echo ultrasonic gesture sensing technology. In these types of systems, ultrasonic signals are transmitted from an ultrasonic transmitter, and reflected signals are received by an ultrasonic receiver. One challenge for these types of systems is to distinguish between direct reflections from a primary reflector (a primary target of interest) and multipath reflections from other reflectors in the field of view. These multipath reflections are unwanted signals that interfere with gesture sensing.

A typical ultrasonic system removes these unwanted multipath reflections using additional information, such as information from other ultrasonic transmitter-receiver pairs, to determine which reflections are not from the primary target. The system can then discard the undesired multipath reflections. This approach works well for primary targets that provide very strong reflections to an ultrasonic receiver. However, some primary targets provide weak reflections due to their ultrasonic reflective cross-sections or due to decreases in signal strength from dispersion or attenuation of the ultrasound signal with increased distance to an ultrasonic receiver, making it difficult to detect those targets.

### BRIEF DESCRIPTION OF DRAWINGS

For a more complete understanding of this disclosure and its features, reference is now made to the following description, taken in conjunction with the accompanying drawings, in which:

FIGS. 1 through 4 illustrate example ultrasonic gesture recognition systems supporting multipath reflection processing in accordance with this disclosure;

FIGS. 5A and 5B illustrate an example multipath reflection processing in accordance with this disclosure; and

FIG. 6 illustrates an example method for multipath reflection processing in an ultrasonic gesture recognition system in accordance with this disclosure.

### DETAILED DESCRIPTION

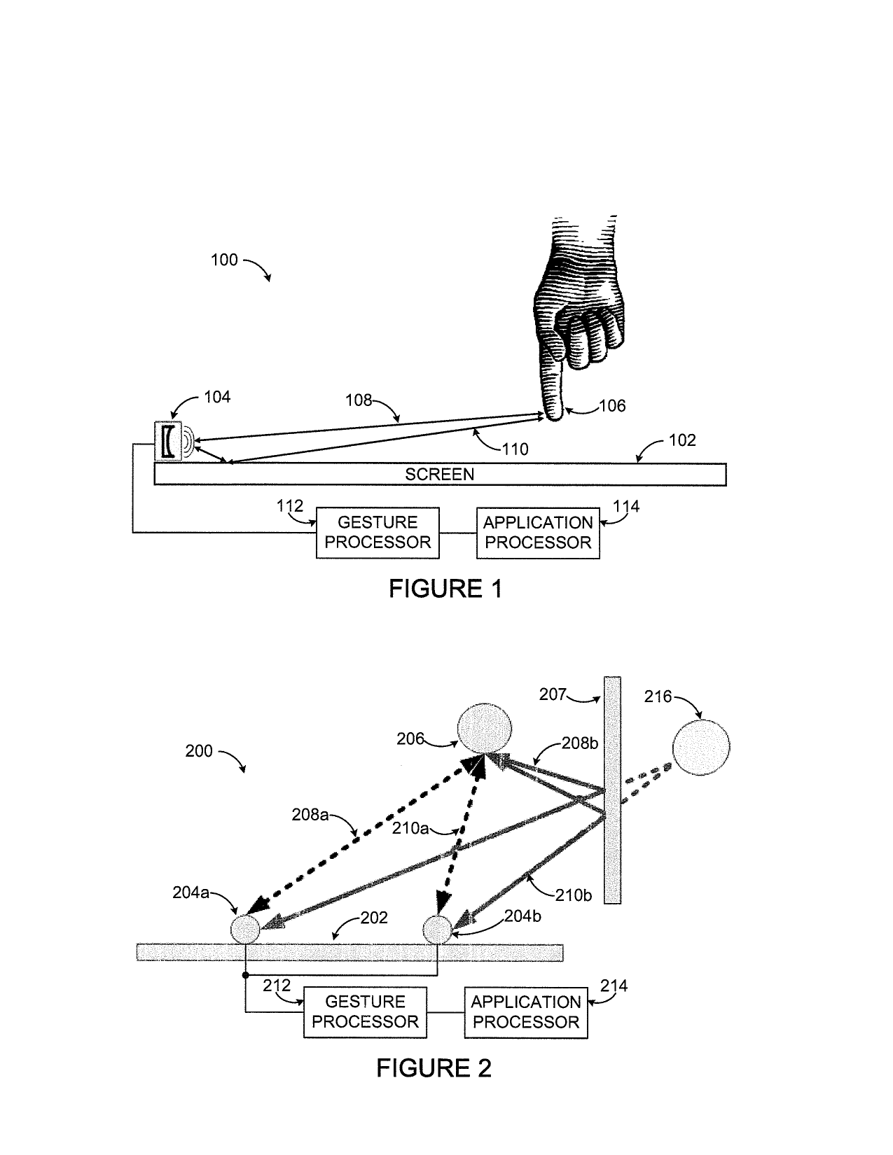

FIG. 1 through 6, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

FIGS. 1 through 4 illustrate example ultrasonic gesture recognition systems supporting multipath reflection processing in accordance with this disclosure. In general, these systems achieve improved ultrasonic gesture recognition by using information contained in static multipath reflections to enhance direct reflections from a primary target, rather than simply discarding the multipath reflections. By using the information contained in the multipath reflections, these systems can help to mitigate problems associated with multipath reflections, while at the same time improving the signal strength of direct reflections received directly from the primary target.

As shown in FIG. 1, an ultrasonic gesture recognition system 100 is used in conjunction with a display screen 102. The display screen 102 represents any suitable structure for visually presenting information to a user. For example, the display screen 102 could represent a liquid crystal display (LCD) or a light emitting diode (LED) display. The display screen 102 may or may not include internal touch-sensitive structures, such as capacitive electrodes or resistive lines.

An ultrasonic transducer 104 is mounted on or near the display screen 102. The ultrasonic transducer 104 transmits and receives ultrasonic signals in order to help identify a location of at least one target 106 near the display screen 102. In this example, the target 106 represents a user's finger, although any other suitable target(s) could be detected.

Here, the ultrasonic transducer 104 emits and receives ultrasonic signals 108-110. Some ultrasonic signals travel directly towards the target 106 and are received directly from the target. Other ultrasonic signals travel directly towards the target 106 and are received indirectly from the target via some other reflector (namely the display screen 102). Yet other ultrasonic signals travel indirectly towards the target 106 via the other reflector and are received directly from the target. Still other ultrasonic signals travel indirectly towards the target 106 and are received indirectly from the target. As a result, the ultrasonic transducer 104 receives multiple sets of ultrasonic reflections, some of which represent multipath reflections. The ultrasonic transducer 104 includes any suitable structure for emitting and receiving ultrasonic signals. While shown as a single integrated unit, an ultrasonic transducer could include an ultrasonic transmitter and a separate ultrasonic receiver. Also, an array of multiple ultrasonic transducers could be used.

A gesture processor 112 analyzes the ultrasonic signals and attempts to identify a location of the target 106. For example, the gesture processor 112 could use time-of-arrival calculations (based on a time between transmitting signals and receiving reflections) to identify the target's location. By tracking the target's location over time, the gesture processor 112 can identify different movements of the target 106 and therefore identify different gestures being made by the target 106 on or near the display screen 102. In addition, as described below, the gesture processor 112 can use information about known reflectors (such as the display screen 102) to help enhance the identification of the target's location(s).

The gesture processor 112 includes any suitable structure for identifying locations of one or more targets and detecting gestures made by the target(s). The gesture processor 112 could, for instance, include a microprocessor, microcontroller, digital signal processor, field programmable gate array, or application specific integrated circuit. In some embodiments, the gesture processor 112 executes software or firmware instructions to provide the desired functionality.

The gesture processor 112 outputs any identified target location(s) and gesture(s) to an application processor 114. The application processor 114 executes one or more applications to provide any desired functionality. For example, the application processor 114 in a mobile smartphone or other device could use the identified location(s) and gesture(s) to initiate or accept telephone calls, send or view instant messages, allow a user to surf the Internet or play games, or any other of a wide variety of functions. As another example, the application processor 114 in a large display screen presenting information (such as in an office building or airport) could use the identified location(s) and gesture(s) to display certain information or invoke certain functions.

The application processor 114 includes any suitable structure for executing one or more applications. The application processor 114 could, for instance, include a microprocessor, microcontroller, digital signal processor, field programmable gate array, or application specific integrated circuit.

In the system 100 of FIG. 1, small aperture ultrasonic transducers are useful in that they can often provide a nearly 180° field of view for the ultrasonic transducer 104. However, as noted above, multipath reflections can interfere with the identification of a target's location. For example, fixed objects within the transducer's field of view (such as the display 102) can act as a plane-wave reflector to ultrasonic signals. These reflectors create multipath interference or ghost images.

Various techniques have been developed for handling multipath reflections, but they all suffer from various drawbacks. For example, a leading reflection approach considers only the first or leading reflection that is received by an ultrasonic receiver, but this does not work well for multi-reflector systems. In a strongest reflection approach, secondary reflections are eliminated by ignoring smaller signals, but this can be unreliable when there are large and small reflections in the field of view at the same time. In a hardware redundancy approach, redundant ultrasonic transmitters or receivers are used to determine a target's location using multi-lateration, although this increases the cost of the overall system. In a beam forming approach, transmit or receive beam-forming uses multiple elements to dynamically position beam nulls to eliminate reflections, although this again increases the cost of the overall system.

In accordance with this disclosure, the gesture processor 112 uses information about known fixed reflectors (also known as static reflectors) to help reduce or eliminate multipath interference problems. This can be done by using the information contained in multipath reflections rather than discarding them. In particular, the gesture processor 112 uses multipath reflections to improve the analysis of the direct reflections received directly from a target. In some embodiments, the gesture processor 112 detects any nearby fixed reflectors during a calibration process. The calibration process could involve the ultrasonic transducer 104 emitting ultrasonic signals and receiving reflections from the nearby reflectors. The calibration process could also involve placing at least one calibration target in at least one known position over the screen 102, and the gesture processor 112 could use ultrasonic reflections from the calibration targets to identify the positions of any nearby reflectors. The position(s) of the fixed reflector(s) can be stored by the gesture processor 112 (such as in a local memory of the gesture processor 112) and used later to identify the location of the target 106. For example, the gesture processor 112 could ignore the multipath reflections from known fixed reflectors or combine the multipath reflections with the direct reflections from the target 106. Additional details regarding this functionality are provided below.

Note that for reasons, one or more fixed reflectors that are detected by the system 100 could be intentionally placed near the system. That is, one or more fixed reflectors could be intentionally incorporated into the design of a device or system. This could be done for any number of reasons, such as to intentionally create multipath reflections that can be used by the system 100 to improve target identification. When a fixed reflector is incorporated into a design, a calibration process may or may not be used to identify the location of that reflector. Rather, prior knowledge of the reflector's location in the design could be used.

As shown in FIG. 2, an ultrasonic gesture recognition system 200 is used in conjunction with a display screen 202. Multiple ultrasonic transducers 204a-204b are mounted on or near the display screen 202. Each ultrasonic transducer 204a-204b transmits and receives ultrasonic signals in order to help identify a location of at least one target 206. The target 206 could represent any suitable object, such as a person approaching a large display screen or a person's finger approaching a small display screen.

In this example, the ultrasonic transducer 204a emits and receives ultrasonic signals 208a, where the received signals are reflected directly from the target 206. Similarly, the ultrasonic transducer 204b emits and receives ultrasonic signals 210a, where the received signals are reflected directly from the target 206. Other ultrasonic signals 208b are reflected off the target 206 and a fixed reflector 207 (such as a wall, table, or other object) before being received by the ultrasonic transducer 204a. Also, other ultrasonic signals 210b are reflected off the target 206 and the fixed reflector 207 before being received by the ultrasonic transducer 204b.

A gesture processor 212 analyzes the ultrasonic signals and attempts to identify a location of the target 206, such as by using time-of-arrival or angle-of-arrival calculations that identify distances or angles of a target from the ultrasonic transducers 204a-204b. Note that various calculations often require the use of multiple ultrasonic transmitters or receivers. The gesture processor 212 outputs any identified location(s) and gesture(s) to an application processor 214, which uses this information to provide any desired functionality.

In this example, the direct reflections (signals 208a and 210a) can be used by the gesture processor 212 to triangulate the location of the target 206. However, without additional information, the gesture processor 212 could use the two multipath reflections (signals 208b and 210b) to triangulate the location of a ghost target 216.

To help avoid this, the ultrasonic transducers 204a-204b can emit ultrasonic signals during a calibration process (with or without one or more calibration targets at one or more known locations). During this process, the gesture processor 212 can analyze ultrasonic reflections to identify the location(s) of any fixed reflector(s) around the ultrasonic transducers 204a-204b. In this case, the gesture processor 212 could identify the location of the fixed reflector 207. As noted above, prior knowledge of the fixed reflector's location could also be used, and the calibration process could be omitted. During normal operation, the gesture processor 212 could determine that the ultrasonic signals 208a and 210a are ultrasonic reflections received directly from the target 206. The gesture processor 212 could also use the known location of the reflector 207 to identify the ultrasonic signals 208b, 210b as multipath reflections. The multipath reflections can then be ignored or combined with the ultrasonic signals 208a, 210a for use in identifying the target's location. In this way, the gesture processor 212 can ignore multipath reflections or actually use the multipath reflections to help in the identification of the target's location.

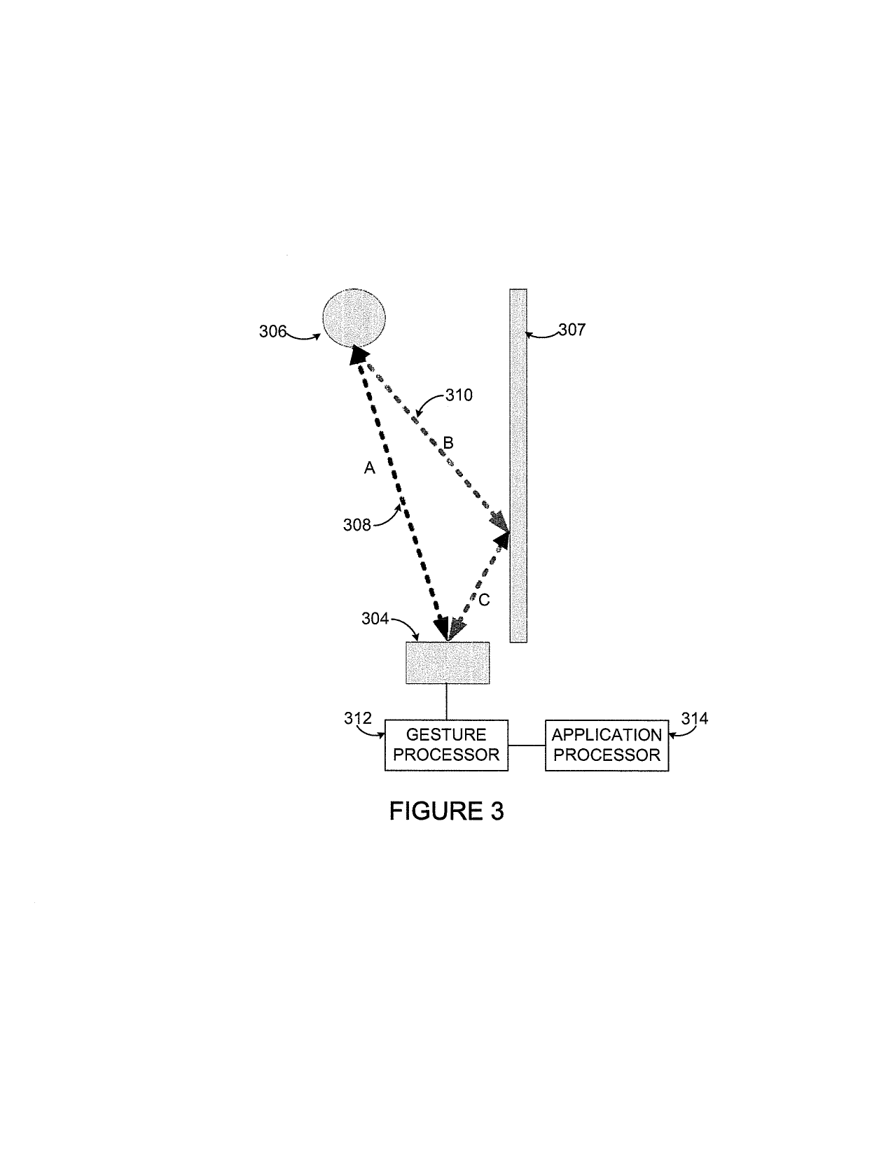

As shown in FIG. 3, an ultrasonic gesture recognition system 300 includes an ultrasonic transducer 304, which could be mounted on or near a display screen or in any other suitable location. The ultrasonic transducer 304 emits and receives ultrasonic signals 308-310, which includes ultrasonic signals received directly from the target 306 and ultrasonic signals received indirectly from the target 306 via a fixed reflector 307. A gesture processor 312 analyzes the ultrasonic signals to identify location(s) and gesture(s) of the target 306. An application processor 314 uses the identified location(s) and gesture(s) to provide any suitable functionality.

In this example, the gesture processor 312 can operate in a similar manner as in FIG. 2. Namely, the gesture processor 312 can identify the location(s) of any fixed reflector(s), such as the reflector 307, during a calibration process or using prior knowledge of the fixed reflector location(s). This information can be used by the gesture processor 312 to help identify which reflections come directly from the target 307 and which reflections are multipath reflections. The gesture processor 312 can then discard the multipath reflections or combine the multipath reflections with the direct reflections from the target 306 to improve the signal strength of the signals from the target. This can help to facilitate easier identification of the target's location.

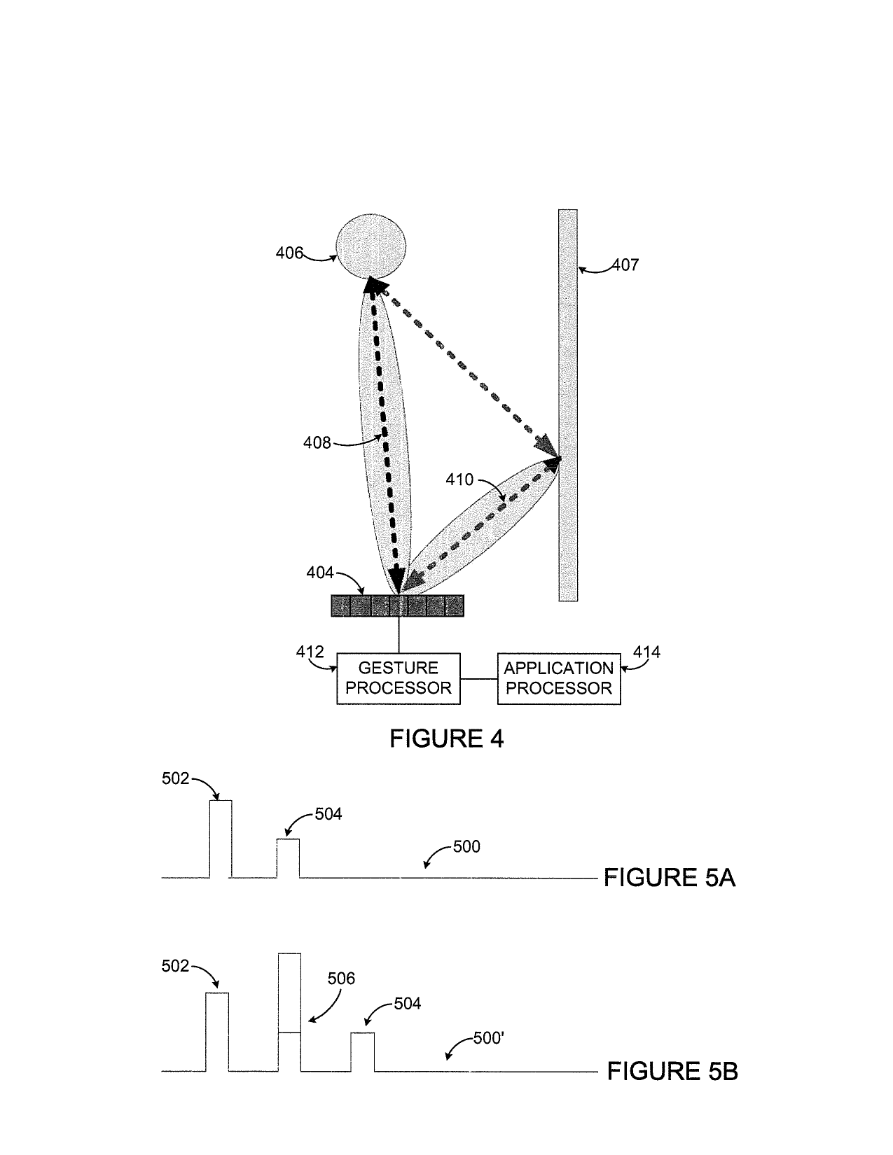

As shown in FIG. 4, an ultrasonic gesture recognition system 400 includes an array 404 of ultrasonic transducers, which could be mounted on or near a display screen or in any other suitable location. The array 404 emits ultrasonic signals, including signals sent towards a target 406. The array 404 also receives both ultrasonic signals 408 directly from the target 406 and ultrasonic signals 410 indirectly from the target 406 via a fixed reflector 407. A gesture processor 412 analyzes the ultrasonic signals to identify location(s) and gesture(s) of the target 406. An application processor 414 uses the identified location(s) and gesture(s) to provide any suitable functionality.

When an array 404 of ultrasonic transmitters and/or receivers is used, it is possible to track the target 406 using beam-steering. For example, using prior knowledge of the location of the fixed reflector 407, it is possible to track the multipath reflections from the target 406 off the fixed reflector 407. The multipath reflections can either be discarded (such as by creating a null in the beam pattern of the ultrasonic receiver array), or they can be enhanced (such as by using receive beam steering to create a secondary receiver beam pattern towards the fixed reflector 407 to detect the multipath signals in addition to the direct target signals).

This approach can be useful in various situations, such as with the detection of non-symmetric targets. Non-symmetric targets typically reflect energy in a non-uniform pattern. For some targets, multipath reflections off the fixed reflector 407 could be stronger than direct reflections. By tracking both the direct reflections (signals 408) and the multipath reflections (signals 410), the array 404 can receive reflections off the target 406 from two different angles, improving the average uniformity of the reflection cross-section of non-uniform targets.

FIGS. 5A and 5B illustrate an example multipath reflection processing in accordance with this disclosure. The multipath reflection processing shown here is described with respect to the system 300 shown in FIG. 3. However, similar processing could occur in the systems shown in FIGS. 1, 2, and 4 (or any other suitable arrangement).

As shown in FIG. 5A, two pulses 502-504 are contained in received ultrasonic signals. The first pulse 502 comes from a direct reflection, and the second pulse 504 comes from a multipath reflection.

The gesture processor 312 can use prior knowledge of the location of the fixed reflector 307 to improve gesture recognition by allowing the gesture processor 312 to use the multipath reflections. For example, the gesture processor 312 can improve the power of reflections received directly from the target 306 by adding the received signal 500 to a time-shifted version of itself, generating a signal 500′ as shown in FIG. 5B.

The amount of time by which the time-shifted version of the signal 500 is shifted can be calculated in any suitable manner. For instance, the gesture processor 312 could create the time-shifted version of the signal 500 by shifting the signal 500 in an amount equal to the distance between two consecutive pulses in the signal 500. More specifically, given predefined knowledge of the reflector's location, the amount of time by which the time-shifted version of the signal 500 is shifted can be calculated as [(B+C)−A]/V, where A through C are the distances shown in FIG. 3 and V is the speed of the transmitted signal (note that this simple illustration does not account for amplitude issues arising from pulse reflection correlation). By adding the signal 500 to its time-shifted version, the resulting signal 500′ contains a combined pulse 506, which represents a combination of the pulses 502-504 from the direct and multipath reflections. The combined pulse 506 can then be used by the gesture processor 312 to identify the location of the target 306.

By using knowledge of one or more reflector locations, target detection is improved since multipath reflections can be ignored or used to obtain improved signal gain. The improved signal gain is obtained since multipath reflections can be combined with direct reflections. As a result, extended range can be obtained by using the environment to actually maximize reflected signals received from a target, improving the robustness of the overall system. It is possible to receive a return from a smaller target or a target at a larger distance with greater probability.

Note that while FIGS. 1 through 4 show some of the ultrasonic reflections in the systems 100-400, not all reflections may be shown here. For example, ultrasonic signals from the transducer 204a could reflect off the reflector 207 and then off the target 206 before being received by the transducer 204b. These additional reflections create additional pulses in received ultrasonic signals that can be discarded by the gesture processor or combined with direct reflection pulses based on preexisting knowledge of known reflector locations.

Although FIGS. 1 through 4 illustrate examples of ultrasonic gesture recognition systems supporting multipath reflection processing, various changes may be made to FIGS. 1 through 4. For example, one or more features in one figure could be used in another figure. As particular examples, the system 100 could include multiple transducers, or the systems 100-300 could each include one or multiple transducer arrays. Also, the functional division in each figure is for illustration only. Various components in each figure could be combined, subdivided, or omitted and additional components could be added according to particular needs. As a particular example, the functionality of the gesture and application processors could be combined into a single processing unit. Although FIGS. 5A and 5B illustrate one example of multipath reflection processing, various changes may be made to FIGS. 5A and 5B. For example, the signals and pulses shown here are for illustration only, and other signals could include any number of direct and multipath reflection pulses.

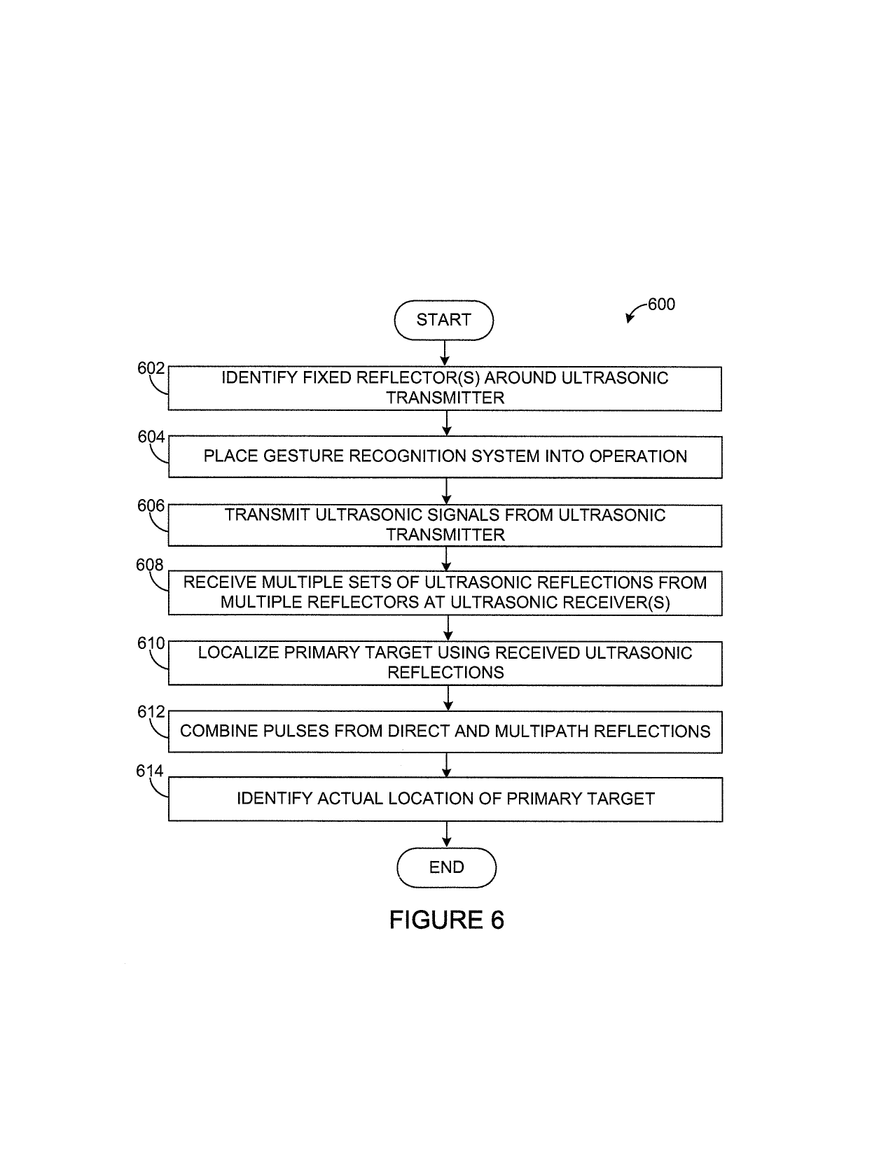

FIG. 6 illustrates an example method 600 for multipath reflection processing in an ultrasonic gesture recognition system in accordance with this disclosure. As shown in FIG. 6, any fixed reflectors around at least one ultrasonic transmitter are identified at step 602. This could include, for example, transmitting ultrasonic signals from the ultrasonic transmitter(s) and receiving any reflections from reflectors around the ultrasonic transmitter(s). This may or may not involve placing a known target at a known location around the ultrasonic transmitter(s). This could occur during a calibration process involving a gesture recognition system. This calibration process could occur at any suitable time(s), such as during manufacture of a mobile smartphone or after installation of a large display screen. The calibration process could also occur any number of times.

After calibration, the gesture recognition system is placed into operation at step 604. During this time, ultrasonic signals are transmitted from the ultrasonic transmitter(s) at step 606. Multiple sets of ultrasonic reflections are received by at least one ultrasonic receiver at step 608. This could include, for example, the ultrasonic receiver(s) receiving ultrasonic reflections directly from a target. This could also include the ultrasonic receiver(s) receiving ultrasonic reflections reflected directly from any other reflectors. This could further include the ultrasonic receiver(s) receiving multipath reflections reflected indirectly from the target off other reflectors.

The ultrasonic reflections are used to localize a primary target at step 610. This could include, for example, a gesture processor using time-of-arrival calculations to estimate distances to actual or ghost targets. More exact target locations could be identified if multiple receivers are present using triangulation or other technique. During this time, the location and configuration of reflectors may be mathematically inferred using multiple receivers, as well.

Pulses from the direct and multipath reflections are combined at step 612. This could include, for example, the gesture processor receiving a signal 500 and combining it with a time-delayed version of itself to create a signal 500′. The signal 500′ can contain combined pulses representing combinations of direct reflection pulses and multipath reflection pulses.

The actual location of the primary target is identified at step 614. This could include, for example, the gesture processor using the combined pulses to identify the location of the target. The combination of pulses helps to provide improved signal gain, which can help to improve target identification. The time-of-arrival of a multipath signal, given knowledge of the location of a reflector, can be used to refine the location of the target through geometric calculations. In a system with multiple transducers, an initial estimate of the position of a target can be confirmed by the existence of expected multipath signals, allowing classification of system noise and false reflections.

Although FIG. 6 illustrates one example of a method 600 for multipath reflection processing in an ultrasonic gesture recognition system, various changes may be made to FIG. 6. For example, while shown as a series of steps, various steps in FIG. 6 could overlap, occur in parallel, occur in a different order, or occur multiple times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
identifying a position of a static reflector near an ultrasonic transmitter;
transmitting ultrasonic signals from the ultrasonic transmitter;
receiving reflected ultrasonic signals at an ultrasonic receiver, the received ultrasonic signals comprising a direct reflection directly from a target and a multipath reflection indirectly from the target via the reflector; and
identifying a location of the target using the reflections and the identified position of the reflector.

2. The method of claim 1, wherein identifying the position of the reflector comprises identifying the position of the reflector during a calibration process prior to transmitting the ultrasonic signals towards the target.

3. The method of claim 1, wherein identifying the location of the target comprises:
using the identified position of the reflector to determine which pulses in the received ultrasonic signals are from the direct reflection and which pulses in the received ultrasonic signals are from the multipath reflection.

4. The method of claim 3, wherein identifying the location of the target further comprises:
discarding the pulses in the received ultrasonic signals from the multipath reflection.

5. The method of claim 3, wherein identifying the location of the target further comprises:
combining the pulses in the received ultrasonic signals from the direct reflection with the pulses in the received ultrasonic signals from the multipath reflection.

6. The method of claim 5, wherein combining the pulses comprises:
generating a time-delayed version of the received ultrasonic signals; and
combining the received ultrasonic signals and the time-delayed version of the received ultrasonic signals.

7. The method of claim 1, wherein:
transmitting the ultrasonic signals comprises transmitting ultrasonic signals from multiple ultrasonic transmitters; and
receiving the reflected ultrasonic signals comprises receiving reflected ultrasonic signals at multiple ultrasonic receivers.

8. The method of claim 1, further comprising:
identifying a gesture made by the target using multiple identified locations of the target.

9. An apparatus comprising:
a processing unit configured to:
identify a position of a static reflector near an ultrasonic transmitter;
initiate transmission of ultrasonic signals from the ultrasonic transmitter;
receive information identifying reflected ultrasonic signals received at an ultrasonic receiver, the received ultrasonic signals comprising a direct reflection directly from a target and a multipath reflection indirectly from the target via the reflector; and
identify a location of the target using the reflections and the identified position of the reflector.

10. The apparatus of claim 9, further comprising:
at least one ultrasonic transducer comprising the ultrasonic transmitter and the ultrasonic receiver.

11. The apparatus of claim 9, wherein:
the processing unit is configured to identify a gesture made by the target using multiple identified locations of the target; and
the apparatus further comprises a second processing unit configured to use the identified gesture.

12. The apparatus of claim 9, wherein the processing unit is configured to identify the position of the reflector during a calibration process prior to initiating transmission of the ultrasonic signals towards the target.

13. The apparatus of claim 9, wherein the processing unit is configured to identify the location of the target by using the identified position of the reflector to determine which pulses in the received ultrasonic signals are from the direct reflection and which pulses in the received ultrasonic signals are from the multipath reflection.

14. The apparatus of claim 13, wherein the processing unit is configured to identify the location of the target by discarding the pulses in the received ultrasonic signals from the multipath reflection.

15. The apparatus of claim 13, wherein the processing unit is configured to identify the location of the target by combining the pulses in the received ultrasonic signals from the direct reflection with the pulses in the received ultrasonic signals from the multipath reflection.

16. The apparatus of claim 15, wherein the processing unit is configured to combine the pulses by:
generating a time-delayed version of the received ultrasonic signals; and
combining the received ultrasonic signals and the time-delayed version of the received ultrasonic signals.

17. A computer readable medium embodying a computer program, the computer program comprising computer readable program code for:
identifying a position of a static reflector near an ultrasonic transmitter;
initiating transmission of ultrasonic signals from the ultrasonic transmitter;
receiving information identifying reflected ultrasonic signals received at an ultrasonic receiver, the received ultrasonic signals comprising a direct reflection directly from a target and a multipath reflection indirectly from the target via the reflector; and
identifying a location of the target using the reflections and the identified position of the reflector.

18. The computer readable medium of claim 17, wherein the computer readable program code for identifying the location of the target comprises:
computer readable program code for using the identified position of the reflector to determine which pulses in the received ultrasonic signals are from the direct reflection and which pulses in the received ultrasonic signals are from the multipath reflection.

19. The computer readable medium of claim 18, wherein the computer readable program code for identifying the location of the target further comprises:
computer readable program code for discarding the pulses in the received ultrasonic signals from the multipath reflection.

20. The computer readable medium of claim 18, wherein the computer readable program code for identifying the location of the target further comprises:
computer readable program code for combining the pulses in the received ultrasonic signals from the direct reflection with the pulses in the received ultrasonic signals from the multipath reflection.
